(19) United States
(12) Patent Application Publication
(10) Pub. No.: US 2025/0065889 A1
(43) Pub. Date: Feb. 27, 2025

(54) DYNAMICALLY-ADAPTABLE PROXIMITY REGIONS FOR A MOTORCYCLE

(71) Applicant: Indian Motorcycle International, LLC, Medina, MN (US)

(72) Inventor: Jacob R. Horn, North Branch, MN (US)

(21) Appl. No.: 18/724,052

(22) PCT Filed: Nov. 15, 2022
(86) PCT No.: PCT/US2022/049880

§ 371 Date: Jun. 25, 2024

Related U.S. Application Data
(60) Provisional application No. 63/296,901, filed on Jan. 6, 2022.

(51) Int. Cl. B60W 50/00; B60W 50/08; G06V 20/56

(52) U.S. Cl. CPC B60W 50/0098; B60W 50/085; G06V 20/588; B60W 2300/36; B60W 2420/403; B60W 2420/408; B60W 2520/10; B60W 2552/20

(57) ABSTRACT

A method of dynamically defining a region proximal to a motorcycle in a lane of a road, including: determining a lateral position of the motorcycle in the lane of the road; defining a forward proximity region having a forward proximity region shape defined by an outer perimeter of the forward proximity region, a forward length, a first lateral forward width at a first end that extends substantially from the first lane boundary to the second lane boundary along an axis normal to the first and second lane boundaries and that intersects a portion of the motorcycle, and a second lateral forward width at a second end forward of the motorcycle and that is less than the first lateral forward width; and changing the forward proximity region shape based on a change of the lateral position of the motorcycle in the lane of the road.

### RELATED APPLICATIONS

The present patent application is a National Phase entry of PCT Application No. PCT/US2022/049880, filed Jan. 19, 2017, 2016, which claims the benefit of U.S. Provisional Application No. 63/296,901, filed Jan. 6, 2022, the disclosure of which is incorporated by reference in its entirety.

### FIELD OF THE DISCLOSURE

This disclosure relates to advanced driver assistance systems for motorcycles. More specifically, the disclosure relates to systems, devices and methods for determining and dynamically defining proximity regions around a motorcycle.

### BACKGROUND

The use of advanced driver assistance systems (ADAS) in automobiles is well established and increasingly commonplace. ADAS systems include automatic or emergency brake assist systems, adaptive cruise control, forward and rearward collision warnings, lane keeping or changing assistance systems, and many more. These systems not only warn drivers of vehicles of their surroundings and impending danger, but may also autonomously respond to potential collisions by braking, steering or decelerating the vehicle.

For example, in known collision warning or collision avoidance systems, the ADAS monitors the driving lane in front of and/or behind an automobile to determine whether an object, typically another vehicle, is in the lane ahead or behind. If the other vehicle is within a predetermined vicinity or range, an audible or visual warning to the driver may be issued. Depending on several factors, such as relative speed of the vehicles, distance, and so on, typically after a warning, the ADAS may take control of automobile functions, such as braking, to avoid a collision.

However, known ADAS features that are tailored to automobile applications do not fully take into account the behaviors and needs of motorcycle operators.

### SUMMARY

Motorcycle operators use a unique set of criteria to determine how close to other vehicles they are comfortable with while driving. Unlike most automobiles that are relatively large and tend to substantially fill the width of a driving lane, motorcycles are generally smaller than automobiles, and do not fill the entire width of the driving lane. This mean that the motorcyclist may opt to locate the motorcycle in various lateral positions within the lane, for example, in the center of the lane, left of center, right of center, and so on. When riding in a staggered formation, and as described further herein, a group of motorcyclists may ride in relatively close formation, with motorcycles alternating in right-of-center and left-of-center positions.

In a traditional ADAS, and particularly in collision-warning and collision-avoidance systems, the ADAS defines a vicinity, or “proximity region”, in front of, behind, and to a certain extent, to the left and right of the automobile. If another vehicle enters that proximity region, the ADAS warns and/or takes action. Traditional proximity regions are generally rectangular in nature and extend laterally from one lane limit to the other for the full longitudinal length of the region.

However, in the case of a motorcycle which can select any number of positions across the width of the driving lane, proximity regions of an ADAS that span substantially all of the lane width limit the ability of a motorcycle operator to ride in the proximity of other motorcycles, particular when riding in a staggered formation.

Consequently, embodiments of the present disclosure provide dynamically-adaptable proximity regions customized for motorcycle-specific ADAS applications. Embodiments of adaptable proximity regions may be determined and defined without the need to identify a particular type of vehicle sharing the road or proximity of the motorcycle, and sometimes without the need to identify the presence of another vehicle, and are therefore self-identifying adaptable proximity regions.

One embodiment of the disclosure is a method of dynamically defining a region proximal to a motorcycle in a lane of a road. The method comprises: determining a lateral position of the motorcycle in the lane of the road; defining a forward proximity region having a forward proximity region shape defined by an outer perimeter of the forward proximity region, a forward length, a first lateral forward width at a first end that extends substantially from the first lane boundary to the second lane boundary along an axis normal to the first and second lane boundaries and that intersects a portion of the motorcycle, and a second lateral forward width at a second end forward of the motorcycle and that is less than the first lateral forward width; and changing the forward proximity region shape based on a change of the lateral position of the motorcycle in the lane of the road.

Another embodiment of the disclosure is a method of operating a motorcycle. The method comprises: obtaining lane-boundary information using a sensor of the motorcycle, the lane-boundary information relating to one or more lane boundaries that define a lane of a road; determining a first lateral position of the motorcycle within the lane of the road based on the obtained lane-boundary information; defining an adaptable proximity region that includes a first proximity region defined at least in part by the first lateral position of the motorcycle within the lane, the first proximity region defining a first area of the lane proximal to the motorcycle and having a first proximity-region shape and a first proximity-region size; determining a second lateral position of the motorcycle within the lane of the road, the second lateral position of the motorcycle within the lane being different from the first lateral position of the motorcycle within the lane of the road; and redefining the adaptable proximity region to include a second proximity region based on a change in position of the motorcycle from the first lateral position to the second lateral position, the second proximity region defining a second area of the lane having a second proximity-region shape and a second proximity-region size, the second area of the lane being different than the first area of the lane, thereby adapting the adaptable proximity region to the change in lateral position of the motorcycle within the lane.

Yet another embodiment of the disclosure is an advanced driver assistance system (ADAS) for a motorcycle. The ADAS comprises: a first sensor for detecting a boundary of a lane of a road; a control unit in communication with the plurality of sensors via an interface, the control unit including a processor and memory device storing instructions readable by the processor, the processor configured to: receive information from the sensor regarding the boundary of the lane of the road, determine a lateral position of the motorcycle within the lane based at least in part on the information from the sensor, define an adaptable proximity region that includes a first proximity region defined at least in part by the first lateral position of the motorcycle within the lane, the first proximity region defining a first area of the lane proximal to the motorcycle and having a first proximity-region shape and a first proximity-region size; determine a second lateral position of the motorcycle within the lane of the road, the second lateral position of the motorcycle within the lane being different from the first lateral position of the motorcycle within the lane of the road; and redefine the adaptable proximity region to include a second proximity region based on a change in position of the motorcycle from the first lateral position to the second lateral position, the second proximity region defining a second area of the lane having a second proximity-region shape and a second proximity-region size, the second area of the lane being different than the first area of the lane, thereby adapting the adaptable proximity region to the change in lateral position of the motorcycle within the lane; and a warning device in electrical communication with the control unit.

### BRIEF DESCRIPTION OF THE DRAWINGS

The disclosure can be understood in consideration of the following detailed description of various embodiments in connection with the accompanying drawings, in which:

FIG. 1 is top view of a motorcycle in a road lane with an ADAS employing a prior art proximity region;

FIG. 2 is top view of a motorcycle in a road lane with an ADAS employing an adaptable proximity region, according to an embodiment of the disclosure;

FIG. 3 is a top view of a motorcycle with an ADAS with sensors, according to an embodiment of the disclosure;

FIG. 4 is a block diagram of an ADAS, according to an embodiment of the disclosure;

FIG. 5 is top view of a motorcycle positioned centrally in a road lane with an ADAS employing an adaptable proximity region, according to an embodiment of the disclosure;

FIG. 6 is top view of a motorcycle positioned at a left-side of a road lane with an ADAS employing an adaptable proximity region, according to an embodiment of the disclosure;

FIG. 7 is top view of a motorcycle positioned at a right-side of a road lane with an ADAS employing an adaptable proximity region, according to an embodiment of the disclosure;

FIG. 8 is a top view of a motorcycle in a road lane with an ADAS employing an adaptable proximity region, according to an alternate embodiment of the disclosure;

FIG. 9 is a top view of a motorcycle in a road lane with an ADAS employing an adaptable proximity region, according to another alternate embodiment of the disclosure;

FIG. 10 is a top view of a motorcycle in a road lane with an ADAS employing an adaptable proximity region, according to yet another alternate embodiment of the disclosure;

FIG. 11 is top view of a motorcycle in a road lane with an ADAS employing an adaptable proximity region that is adapted for a relatively slow speed, according to an embodiment of the disclosure;

FIG. 12 is top view of a motorcycle in a road lane with an ADAS employing an adaptable proximity region that is adapted for a medium speed, according to an embodiment of the disclosure;

FIG. 13 is top view of a motorcycle in a road lane with an ADAS employing an adaptable proximity region that is adapted for a relatively high speed, according to an embodiment of the disclosure;

FIG. 14 is top view of a motorcycle in a curved road lane with an ADAS employing an adaptable proximity region that is adapted for the road curvature, according to an embodiment of the disclosure;

FIG. 15 is top view of a motorcycle in a road lane with an ADAS employing an adaptable forward proximity region that includes multiple selectable regions, according to an embodiment of the disclosure;

FIG. 16 is top view of a motorcycle in a road lane with an ADAS employing an adaptable rearward proximity region that includes multiple, selectable regions, according to an embodiment of the disclosure;

FIG. 17 is a top view of multiple motorcycles riding single file in a common road lane, each motorcycle having an ADAS employing an adaptable proximity region, according to an embodiment of the disclosure;

FIG. 18 is a top view of multiple motorcycles riding single file in a common road lane, each motorcycle having an ADAS employing traditional, prior art proximity region;

FIG. 19 is a top view of multiple motorcycles riding in a staggered formation in a common road lane, each motorcycle having an ADAS employing a traditional, prior art proximity region;

FIG. 20 is a top view of multiple motorcycles riding in a staggered formation in a common road lane, each motorcycle having an ADAS employing an adaptable forward proximity region, according to an embodiment of the disclosure;

FIG. 21 is a top view of multiple motorcycles riding in a staggered formation in a common road lane, each motorcycle having an ADAS employing an adaptable rearward proximity region, according to an embodiment of the disclosure;

FIG. 22 is a top view of multiple motorcycles riding in a staggered formation in a common road lane, each motorcycle having an ADAS employing an adaptable forward and rearward proximity region, according to an embodiment of the disclosure;

FIG. 23 is a top view of a motorcycle having an ADAS employing an adaptable proximity region following an automobile that is within the forward proximity region, according to an embodiment of the disclosure;

FIG. 24 is a top view of a motorcycle having an ADAS employing an adaptable proximity region following an automobile that is not within the forward proximity region, according to an embodiment of the disclosure;

FIG. 25 is a top view of a motorcycle having an ADAS employing an adaptable proximity region being followed by an automobile that is within the rearward proximity region, according to an embodiment of the disclosure;

FIG. 26 is a top view of a motorcycle having an ADAS employing an adaptable proximity region being followed by an automobile that is not within the rearward proximity region, according to an embodiment of the disclosure;

FIG. 27 is a top view of a motorcycle having an ADAS employing an adaptable proximity region having multiple forward proximity sub-regions;

FIG. 28 is a top view of a motorcycle having an ADAS employing an adaptable proximity region having multiple rearward proximity sub-regions, according to an embodiment of the disclosure;

FIG. 29 is a flow chart depicting a process of dynamically determining a proximity region, according to an embodiment of the disclosure; and

FIG. 30 is a flow chart depicting a process of determining an adaptable proximity region, according to an embodiment of the disclosure.

### DETAILED DESCRIPTION

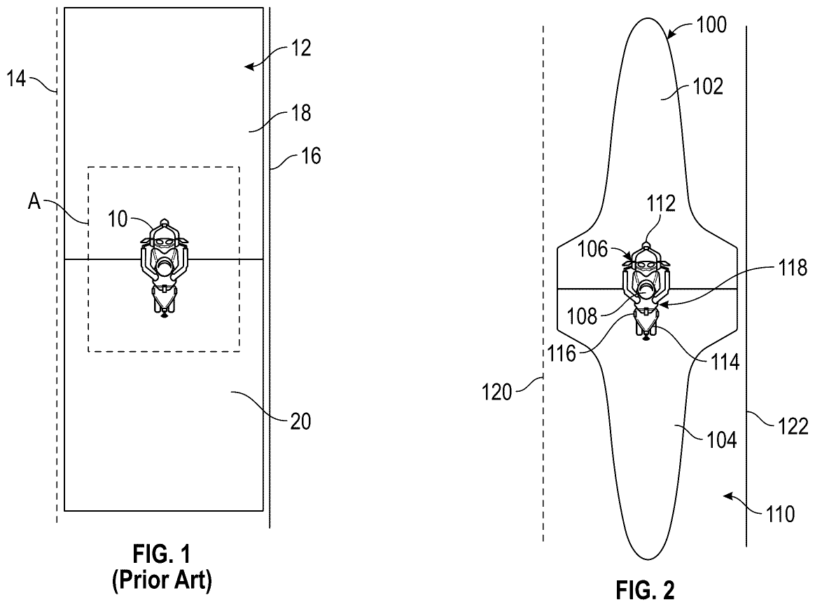

FIG. 1 depicts traditional proximity ranges defined by an ADAS. In FIG. 1, motorcycle 10 is located in lane 12 defined by median 14 and lane edge, limit or boundary 16. The dashed-line rectangle A surrounding motorcycle 10 and its operator represents an automobile outline, and illustrates the relative size difference between a typical motorcycle and an automobile, and in particular, their relative occupation of the space in the lane.

In this traditional ADAS, a forward proximity region 18 is defined as a rectangular area forward from the center of motorcycle 10, and a rearward proximity region 20 is defined as a rectangular area rearward from the center of motorcycle 10. Each proximity region 18 and 20 extends laterally, or left-to-right, between the lane boundaries, or from median 14 to lane edge 16 in the depicted scenario. In a traditional ADAS, such as an ADAS designed for an automobile which occupies a majority of the lateral space between the lane boundaries, defining proximity regions as generally rectangular areas that span nearly the entire lateral width of the driving lane is prudent since an automobile fills nearly the entire width of the lane, and any object within the lane is likely in the path of the automobile, and has potential to collide with the relatively large automobile.

However, in the case of a motorcycle, which is significantly smaller than an automobile, and able to be positioned at various lateral locations in the lane, traditionally-defined proximity regions such as those depicted in FIG. 1 limit the ability of a motorcycle operator to ride in the proximity of other motorcycles, particular when riding in a staggered formation.

Referring to FIG. 2, an embodiment of an adaptable proximity region 100 of a motorcycle-specific ADAS is depicted. Adaptable proximity region 100 comprises forward proximity region 102 and rearward proximity region 104. Motorcycle 106 with operator 108 is positioned within adaptable proximity region 100, and generally in a center of lane 110. Although the term “motorcycle” is used herein, it will be understood that “motorcycle” refers to, and encompasses, any motorized vehicle having a seat or saddle for the use of the operator/rider, and that is designed to travel on not more than three wheels in contact with the ground.

For the purposes of description, a forward direction is defined as a rear end 114 to front end 112 direction and a rearward direction is defined as a front end 112 to rear end 114 direction; a leftward direction is defined as a right side 118 to left side 116 direction; and a rightward direction is defined as a left side 116 to right side 118 direction.

Lane 110 includes a portion of a road, street, highway, freeway or other type of vehicle thoroughfare, and is defined laterally by first, or left-side, lane limit or boundary 120, and second, or right-side lane limit or boundary 122. First lane boundary 120 may be define a separation between lanes of traffic traveling in opposite directions, such as a median, or between lanes of traffic traveling in a same direction. Second lane boundary 122 may define a separation between lane 120 and a road shoulder or road bed, or another lane.

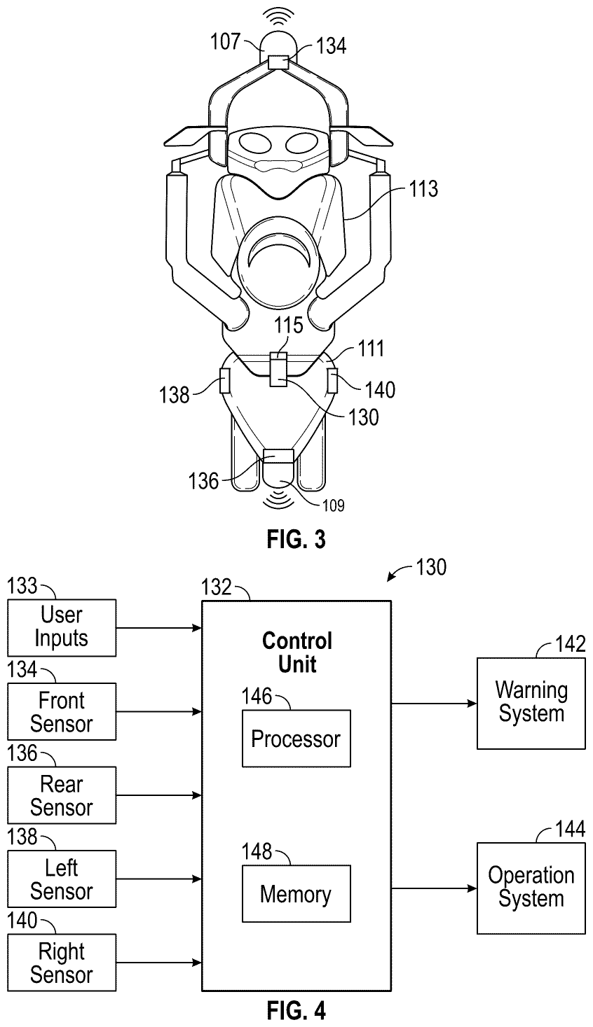

Referring to FIG. 3, motorcycle 106 includes front wheel 107, rear wheel 109, frame 111, engine 113, and at least one electronic control unit (ECU) 115. Embodiments of motorcycle 106, and various components thereof, are generally well known in the art. US Patent Publication 2016/0298807A1, published Oct. 13, 2016, entitled “Two-Wheeled Vehicle,” and owned by Indian Motorcycle International, LLC, describes embodiments of a motorcycle and related systems and components, and is incorporated herein by reference in its entirety.

Motorcycle 106 also includes ADAS 130 that may comprise one or more systems for alerting operator 108 or controlling an operation of motorcycle 106, such as emergency brake assist, autonomous emergency braking, electronic stability control, adaptive cruise control, forward collision warning, rearward collision warning, lane departure warning, lane keep assist, blind spot detection, and so on. ADAS 130 may employ a plurality of cameras and/or sensors or sensing systems 134-140, such as radar, lidar, lean sensors, accelerometers, and other such sensors and systems known to be used in an ADAS. Methods of determining and defining the inventive adaptable proximity regions may be implemented by an ADAS to form motorcycle-specific ADAS 130.

In the embodiment depicted, motorcycle 106 includes front sensor 134, rear sensor 136, left-side sensor 138, and right-side sensor 140.

Referring also to FIG. 4, a block diagram of an embodiment of motorcycle-specific ADAS 130 is depicted. In this exemplary embodiment, ADAS 130 includes control unit 132 in communication with user inputs 133, a plurality of sensors, including front sensor 134, rear sensor 136, left-side sensor 138, and right-side sensor 140, as well as warning system 142 and motorcycle operations system 144. In an embodiment, components of ADAS 130 may be communicatively coupled by a control area network bus (CANBUS).

“User inputs” 133 refers generally to inputs selectively controlled by a user, or operator 108. User inputs 133 may be features or other “inputs” selected by operator 108 via an operator-motorcycle interface, such as a touch screen, voice-recognition system, buttons, switches, and so on. For example, an operator input may include an input from the operator setting an alert threshold for a following distance, or similar preference.

Although the term “sensor” is used, it will be understood that “sensor” is intended to include a variety of possible sensors, sensing systems, image capture devices and systems, as described briefly above. In an embodiment, front sensor 134 includes a front radar system and a front camera; rear sensor 136 includes a rear radar system and a rear camera; left-side sensor 138 includes a camera; and right-side sensor 140 includes a camera. Although four sensors are depicted and described, it will be understood that ADAS 130 may include more or fewer sensors.

In an embodiment, control unit 132 includes at least one processor 146 and memory device 148 storing various computer software control modules implementing methods and systems of the disclosure. Processor 146 may comprise a microprocessor, microcomputer, microcontroller, ASIC, or similar, and may be configured to process signals or data, including executing instructions, such as instructions, computer programs, code, etc., stored in memory 148. Control unit 132 may comprise one or more ECUs of motorcycle 106, or may comprise a separate control unit dedicated to ADAS 130 in communication with an ECU 115 of motorcycle 106. Control unit 132 may also comprise a system communication interface for interfacing with sensors 134-140 and other systems as described below. Memory device 148 may comprise any of various known memory devices, such as a RAM, ROM, EPROM, flash memory and so on.

ADAS 130, in an embodiment, also includes warning system 142 and motorcycle 106 operations system 144. Warning system 142 may comprise any of known warning devices or systems intended to alert operator 108 audibly, visually or haptically, such as warning lights, speakers, display devices and so on. Warning system 142 may comprise all or portions of specific ADASs, such as collision avoidance systems, blind spot detection, and so on. Operations system 144 comprises devices and systems configured to control one or more operations of motorcycle 106, such as braking, acceleration/deceleration, steering, and so on. Operations systems 144 may also comprise all or portions of specific ADASs, such as collision avoidance systems, blind spot detection, and so on.

During operation, control unit 130 receives input from sensors 134-140, processes data according to stored computer program instructions, determines adaptable proximity regions 100 (described further below), and outputs control signals as needed to warning system 142 and operations systems 144, to alert operator 108 or control operations of motorcycle 106 when an obstacle, such as a vehicle, is within adaptable proximity region 100. To determine adaptable proximity region 100, ADAS 130 may be configured to determine locations of left boundary 120, right boundary 122, and a position of motorcycle 106 relative to the lane boundaries, i.e., a lateral position within lane 110. It will be understood that determining the lateral position within lane 110 may comprise determining a distance from the motorcycle 106 to one or both of lane boundaries 120 and 122, determining a distance between lane boundaries 120 and 122, determining a position between lane boundaries 120 and 122, or similar.

ADAS 130 may also receive data from sensors 134-138 to determine locations of lane boundaries 120 and 122, and positions of other vehicles in a proximity of motorcycle 106, and so on.

Although methods of determining and defining adaptable proximity regions 100 may be implemented via the exemplary ADAS 130, other known ADASs may be used to implement the inventive systems and methods for determining and defining adaptable proximity regions 100 as described herein. For example, the following patents and patent publications describe known ADASs, all of which are incorporated by reference herein in their entireties, and may be used to implement systems and methods relating to adaptable proximity regions 100 as described herein: WO 2020/041191 A1, published Feb. 27, 2020, entitled “Wheeled Vehicle Notification System and Method,” and owned by Indian Motorcycle International, LLC; US 2021/0188270, published Jun. 24, 2021, entitled “Wheeled Vehicle Adaptive Speed Control Method and System,” and owned by Indian Motorcycle International, LLC; US 2021/0162998 A1, published Jun. 3, 2021, entitled “Control Device and Control Method for Controlling Behavior of Motorcycle,” and having an applicant Robert Bosch BmbH; US 2020/0231170 A1, published Jul. 23, 2020, entitled “Method and Control Device for Monitoring the Blind Spot of a Two-Wheeled Vehicle,” and having an applicant Robert Bosch GmbH; and U.S. Pat. No. 10,429,501, issued Oct. 1, 2019, entitled “Motorcycle Blind Spot Detection System and Rear Collision Alert Using Mechanically Aligned Radar,” and having an applicant Continental Automotive Systems, Inc.

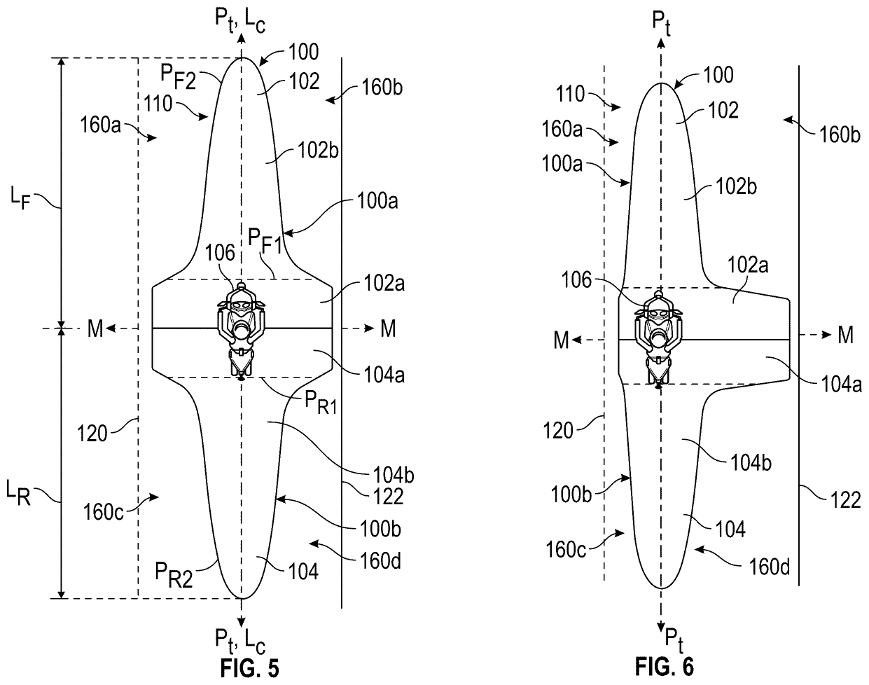

Referring to FIG. 5, adaptable proximity region 100, which includes forward proximity region 102 and rearward proximity 104, is determined and defined based on, at least in part, the lateral position of motorcycle 106 within lane 110. In FIG. 5, motorcycle 106 is positioned in the center of lane 110. Generally, motorcycle 106 is aligned longitudinally along a path-of-travel axis Pt that defines an expected path of travel, or trajectory, of motorcycle 106. In an embodiment, path-of-travel axis Pt may include a line that intersects both front wheel 107 and rear wheel 109 (see also FIG. 4), or may comprise a longitudinal centerline of motorcycle 106. Path-of-travel axis Pt may also comprise, and be determined by, portions of a path already traveled by motorcycle 106, e.g., a path rearward of motorcycle 106 already traveled, or portions of a path forward of motorcycle 106 expected to be traveled.

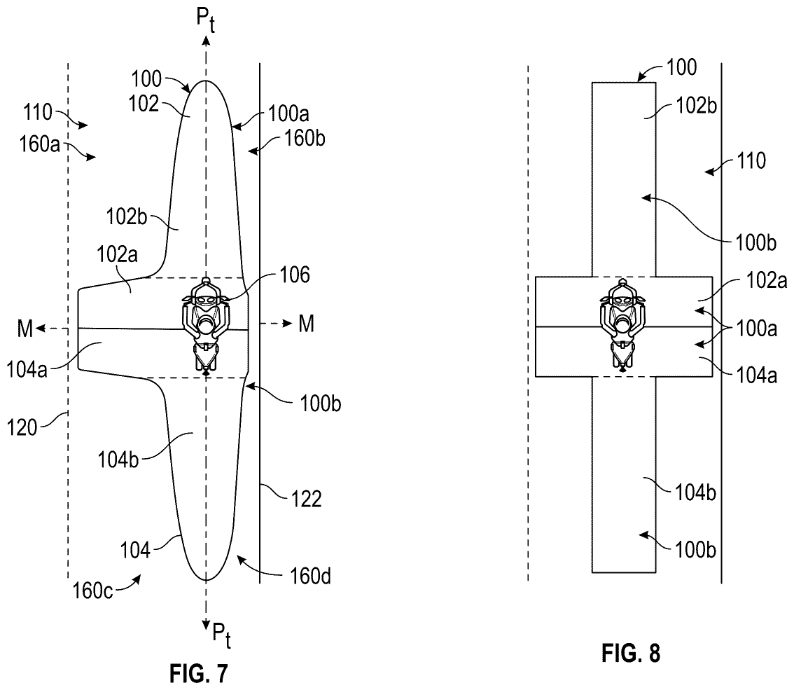

Proximity region 100 extends longitudinally along path-of-travel axis Pt. Motorcycle 106 is laterally positioned at a center of lane 110 along a lateral axis M, which may include a line passing through motorcycle 106, which may be a front-to-back bisecting line. In this depiction, because motorcycle 106 is positioned at a center of lane 110, the path-of-travel axis Pt is the same as a central longitudinal axis Lc of lane 110. As will be described further below with respect to FIGS. 6 and 7, which depict motorcycle 106 positioned to the left and right of the center of lane 110, respectively, as the lateral position of motorcycle 106 changes within lane 110, adaptable proximity region 100 will dynamically change or be adapted according to the changing lateral position. As will also be described in further detail below with respect to FIG. 8, adaptable proximity region 100 allows for tighter formation when multiple motorcycles 106 travel together in a staggered formation.

Still referring to FIG. 5, forward proximity region 102, having a length LF is defined by first forward region 102a and second forward region 102b. First forward region 102a may be defined or described as a lateral forward region, that includes areas forward of axis M that are directly to the left and right to motorcycle 106. Second forward region 102b may be defined or described as a longitudinal forward region, partly or wholly in front of motorcycle 106.

In an embodiment, and as depicted, first forward region 102a and its perimeter P_{F1} may generally form a rectangular shape, though in other embodiments, first forward region 102 may form other rectilinear or curved shapes, including a trapezoidal shape. A width (lateral direction) of first forward region 102a may be greater than a length (longitudinal direction) of first forward region 102a. In an embodiment, a length of first forward region 102a is approximately half the length of motorcycle 106.

In an embodiment, and as depicted, second forward region 102b, extending longitudinally from motorcycle 106, has a length greater than a width, or greater than an average width of second forward region 102b. An average width of second forward region 102b is less than a width of lane 110, i.e., less than the distance between first lane boundary 120 and second boundary 122. In an embodiment, and as depicted, second forward region 102b defines an outer perimeter P_{F1} that is curved, and may be bell shaped as depicted, or may resemble a parabola. In an embodiment, a width of second forward region 102b is greatest nearest motorcycle 106 and decreases in a rear-to-front direction with a minimum width being closets to the most forward end of second forward region 102b, as depicted. In other embodiments, a portion of a perimeter P_{F2} of second forward region 102b may be curved to define a bell curve, parabola or other curvature. In other embodiments, second forward region 102b forms a generally rectangular, triangular, or other shape.

Rearward proximity region 104, having a length L_{R}, is defined by first rearward region 104a and second rearward region 104b. First rearward region 104a may be defined as a lateral rearward region that includes areas rearward of axis M that are to the left and right to motorcycle 106. Second rearward region 104b may be defined as a longitudinal rearward region wholly rearward of motorcycle 106. Although rearward proximity region 104 is depicted as symmetrical about axis M, and having substantially a same size and shape (in mirror image) of forward proximity region 102, it will be understood that in embodiments, forward and rearward proximity regions 102 and 104 may differ in respective size and shape depending on various factors. Such factors may include operator input and preference, e.g., how close to follow a vehicle vs. how closely to be followed by a vehicle, system parameters, e.g., whether both forward and rearward proximity regions are needed, lane conditions, and so on.

In an embodiment, and as depicted, first rearward region 104a and its perimeter P_{R1} may generally form a rectangular shape, though in other embodiments, first rearward region 104 may form other rectilinear or curved shapes, including a trapezoidal shape. A width (lateral direction) of first rearward region 104a may be greater than a length (longitudinal direction) of first rearward region 104a. In an embodiment, a length of first rearward region 104a is approximately half the length of motorcycle 106.

In an embodiment, and as depicted, second rearward region 104b, extending longitudinally from motorcycle 106, has a length greater than a width, or greater than an average width. An average width of second rearward region 104b is less than a width of lane 110, i.e., less than the distance between first lane boundary 120 and second boundary 122. In an embodiment, and as depicted, second rearward region 102b defines an outer perimeter and its perimeter P_{R2} may that is curved, and may be bell shaped as depicted. A width of second rearward region 104b is greatest nearest motorcycle M and decreases in a front-to-rear direction, with a minimum width being closest to the most rearward of second rearward region 104b. In other embodiments, a perimeter P_{R2} of second rearward region 104b may be curved to define a parabola or other curvature. In other embodiments, second rearward region 104b forms a generally rectangular shape.

First forward region 102a and first rearward region 104a in combination define lateral proximity region 100a; second forward region 102b and second rearward region 104b in combination define longitudinal proximity region 100b.

In an embodiment, adaptable proximity region 100 will extend to both lateral limits or boundaries 122 and 124 of lane 110 for longitudinal distances that are relatively close to front end 112 and rear end 114 of motorcycle 106 (as respectively indicated by horizontal dashed lines at front end 112 and rear end 114 in FIG. 5). In another embodiment, adaptable proximity region 110 will extend substantially to both lateral limits or boundaries 122 and 124 of lane 110 for longitudinal distances that are relatively close to front end 112 and rear end 114 of motorcycle 106. In other words, all or portions of lateral proximity region 100a will laterally extend the entire distance, or substantially the entire distance, between first lane boundary 120 and second lane boundary 122 in areas of lane 110 directly laterally adjacent to motorcycle 106.

In an embodiment, adaptable proximity range 100, including lateral proximity region 100a, will not extend laterally beyond or outside of first and second lane boundaries 122 and 124.

Referring also to FIGS. 6 and 7, the parameters, including shape and size, of adaptable proximity region 100 will be adapted and changed dynamically by ADAS 130 to account for the relative location of motorcycle 106 within its current lane 110, and in some embodiments, to account for other factors, as described below. Generally, in embodiments, lateral proximity region 102a will not change greatly in size and shape, and will extend laterally from first lane boundary 120 to second lane boundary 122, such that the width of lateral proximity region 102a is the same as, or substantially the same as, the distance between lane boundaries, independent of the position of motorcycle 106 in lane 110, and the length is the same as, substantially the same as, or approximate to, the length of motorcycle 106.

Conversely, the longitudinal components of adaptable proximity region 100, namely longitudinal region 102b (longitudinally extending second forward and rearward regions 102b, 104b), will be dynamically aligned by ADAS 130 along the path-of-travel axis Pt of motorcycle 106. As such, when a position of motorcycle 106 moves laterally within lane 110, longitudinal region 102b of adaptable proximity region 100 likewise shifts laterally within lane 110, following the lateral position and path-of-travel axis Pt of motorcycle 106. In other words, adaptable proximity region 100 adapts to the lateral position of motorcycle 106 in lane 110.

Unlike known proximity regions that laterally span the entire width of a lane over the proximity region's entire length, adaptable proximity region 100 customizes the area lane 110 considered relevant to the safety of operator 110. Because of the relatively small size, and particularly narrow width of motorcycles as compared to automobiles, certain forward and rearward areas proximate motorcycle 106 that are not aligned with, or close to, the path of travel of motorcycle 106 are of less concern, such that objects in these less relevant portions of lane 110 do not warrant an operator warning or autonomous intervention of operation of motorcycle 106. Such areas within lane 110 and outside of adaptable proximity region 100 include forward-left lane area or “space” 160a, forward-right lane area or space 160b, rearward-left lane area or space 160c and forward-right lane area or space 160d.

Areas directly to the left and right of motorcycle 106 across the entire lane 110 are generally considered relevant to operator 108 since an object immediately adjacent to motorcycle 106 anywhere in lane 110 poses a potential safety hazard, or at least warrants attention by operator 108. As such, as adaptable proximity region 100 dynamically adapts to the changing lane position of motorcycle 106, in an embodiment, lateral region 102a of adaptable proximity region 100 remains relatively constant in size and shape.

Referring specifically to FIG. 6, motorcycle 106 is laterally positioned to the left of center of lane 110. With this left-side position of motorcycle 106, the path-of-travel axis Pt of motorcycle 106 has shifted leftward of the centerline of lane 110. Adaptable proximity region 100 is adapted by ADAS 130 to the change in position, and dynamically reshaped to include relevant areas of lane 110, primarily by adjusting longitudinal region 102b to the left to include path-of-travel axis Pt.

Referring to FIG. 7, motorcycle 106 is laterally positioned to the right of center of lane 110. With this right-side position of motorcycle 106, the path-of-travel axis Pt of motorcycle 106 has shifted right. Adaptable proximity region 100 is adapted by ADAS 130 to the change in position, and dynamically reshaped to include relevant areas of lane 110, primarily by adjusting longitudinal region 102b to the right.

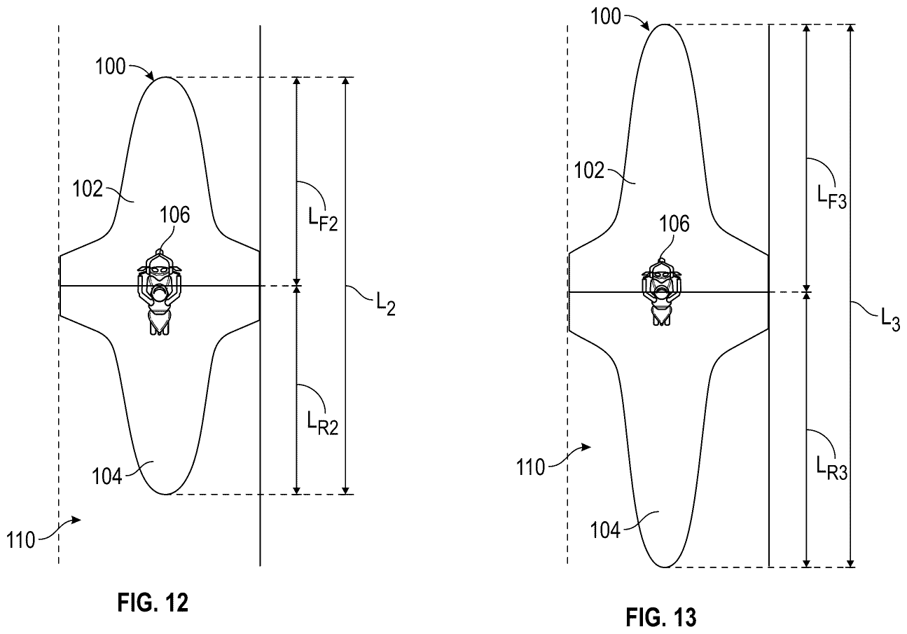

In some instances, it may be possible that one or both lane boundaries 120, 122 are undetectable. This may occur, for example, when lane paint is worn, or lane markers otherwise damaged or undetectable. In an embodiment, in the event that one or both of lane boundaries 120 and 122 are undetectable, ADAS 130 may assume or implement a “default” proximity region 100. In one such embodiment, ADAS implements proximity region 100 of FIG. 5, which may define a symmetrical proximity region. The proximity region 100, even if defaulted to that of FIG. 5 due to a lack of lane boundary 120, 122 information, may be redefined based on features described below with respect to FIGS. 12-16.

In an embodiment where one lane boundary is detectable, ADAS 130 may implement a proximity region 100 according to FIG. 6 or 7. In one such embodiment, if ADAS 130 detects a distance to the one detected lane boundary as being below a predetermined distance threshold, then defines a proximity region 100 based on the detected distance. In one such embodiment, ADAS 130 detects motorcycle 106 as being relatively close to a left lane boundary 120, then defines and implements a proximity region 100 that is similar to that of FIG. 6.

As briefly described above, adaptable proximity region 100 may comprise shapes and configurations other than those depicted in FIGS. 5-7. Referring to FIGS. 8-10, alternate embodiments of adaptable region 100 within lane 110 are depicted.

Referring specifically to FIG. 8, adaptable proximity region 100 comprises a rectangular lateral region 102a and a rectangular lateral region 102b. First forward region 102a, second forward region 102b, first rearward region 104a and second rearward region 104b are all generally rectangular.

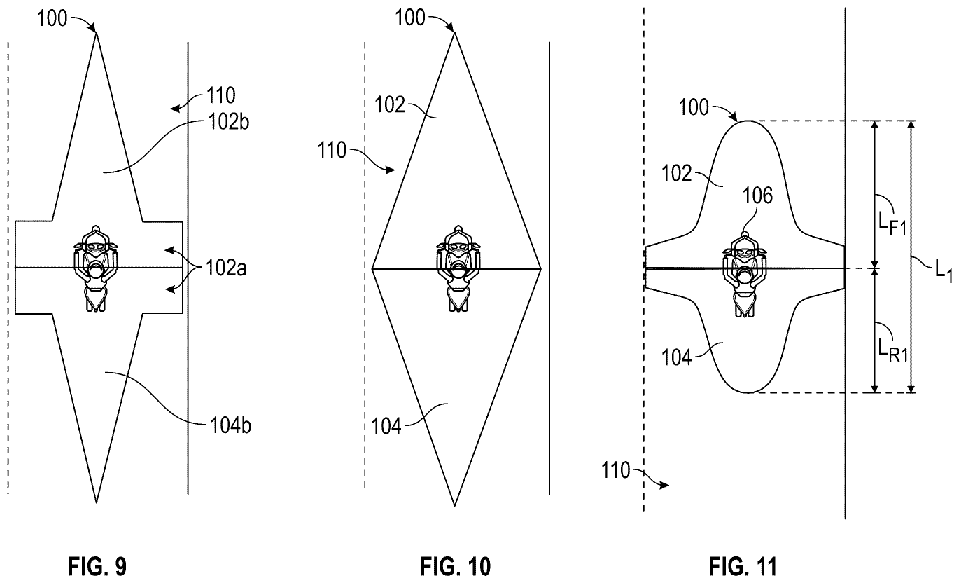

Referring to FIG. 9, adaptable proximity region 100 comprises a rectangular lateral region 102a, and triangular longitudinal regions 102b and 104b. a rectangular lateral region 102b. First forward region 102a, second forward region 102b, first rearward region 104a and second rearward region 104b are all generally rectangular.

Referring to FIG. 10, adaptable proximity region comprises a triangular forward region 102 and a triangular rearward region 104.

Embodiments of adaptable proximity region 100 may comprise the various shapes and configurations of adaptable proximity region 100 depicted and described above with respect to FIGS. 5-10, but are not necessarily limited only to those depicted and described.

Referring to FIGS. 11-13, adaptable proximity region 100 may adapt and change automatically in accordance with motorcycle 106 speed, motorcycle 106 speed relative to a moving object, or the speed of a moving object in or near lane 110. FIG. 11 depicts adaptable proximity region 100 adapted to a relatively slow speed, for example, 30 mph; FIG. 12 depicts adaptable proximity region 100 adapted to a speed greater than the speed of FIG. 11, for example, 55 mph; and FIG. 13 depicts adaptable proximity region 100 adapted to a speed greater than the speeds of FIGS. 11 and 12, for example, 70 mph. As depicted and described further below, with increasing speed, ADAS 130 dynamically increases the length of adaptable proximity region 100, and conversely, with decreasing speed, ADAS 130 dynamically decreases the length of adaptable proximity region 100.

In FIG. 11, based on a relatively lower speed, an overall length of adaptable proximity region 100 is L₁, which is the sum of the length L_{F1} of forward proximity region 102 and the length L_{R1} of rearward proximity region 104.

In FIG. 12, based on a speed higher than the speed of motorcycle 106 of FIG. 11, an overall length of adaptable proximity region 100 is L₂, which is the sum of the length L_{F2} of forward proximity region 102 and the length L_{R2} of rearward proximity region 104.

In FIG. 13, based on a relatively high speed, an overall length of adaptable proximity region 100 is L₃, which is the sum of the length L_{F3} of forward proximity region 102 and the length L_{R3} of rearward proximity region 104.

As is evident from FIGS. 11-13, high-speed length L₃ is greater than lengths L₁ and L₂, and medium-speed length L₂ is greater than slow-speed length L₁. Dynamically changing the length of adaptable proximity region 100 based on speed improves the safety of operator 108. As speeds increase, longer distances are traveled in shorter periods of time. Without dynamic proximity-length adaptability, an operator 108 would be left with less time to react to a forward and perhaps a rearward collision warning. With dynamic proximity-length adaptability, operator 108 may be provided with a similar period of time during which to react to a collision warning.

Further, proximity region 100 may be determined based on one or more predetermined times to collision, which may include a calculation based on one or more of motorcycle 106 speed, speed of an object in or near lane 110, and distance to the object.

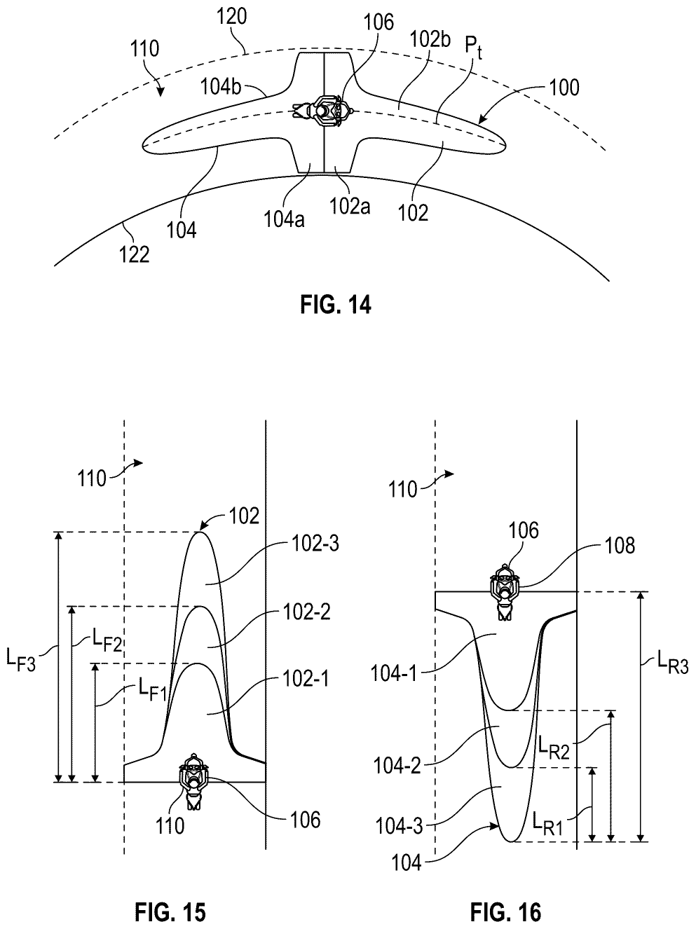

Referring to FIG. 14, adaptable proximity region 100 may further be adapted to match the curvature of the road, including lane 110. Forward proximity region 102b and rearward proximity region 104b still extend further longitudinally than laterally, but this extension of the forward and rearward proximity regions is extended along an arc that matches the curvature of lane 110.

For the sake of illustration, motorcycle 106 is depicted at a laterally central position in lane 110, although it will be understood that motorcycle 106 may be laterally positioned in lane 110, and that ADAS 130 will not only take into account lane curvature, but will also take into account the lateral position of motorcycle 106 in lane 110 to adapt proximity region 100, as described above.

As depicted, each of first lane boundary 120 and second lane boundary 122 defines a respective boundary curvature, which also defines a curvature of lane 110. Based on input from sensors 134-140 (see FIG. 4), which may include cameras imaging first and second lane boundaries 120, 122, ADAS 130 dynamically determines and defines adaptable proximity region 100 to follow or accommodate the curvature of lane 110. In an embodiment, control unit 132 of ADAS 130 may determine or calculate lane boundary curvatures and/or may calculate an expected, non-linear trajectory, or curved path of travel Pt of motorcycle 106. As such, for curved lanes 110, ADAS 130 defines adaptable proximity region 100 that takes into account, or matches, the curvature of lane 110, as well as the expected curved path of travel Pt of motorcycle 106 through the curve of lane 110. In an embodiment, the expected curved path of travel Pt of motorcycle 106 may be different than the curvature of lane 110, i.e., motorcycle 106 is not necessarily following the exact curvature of lane 110, and proximity region 100 may be determined based on either or both the expected curved path of travel Pt, or expected travel trajectory, of motorcycle 106 and the curvature of lane 110.

In an embodiment, lateral portions of adaptable proximity region 100, e.g., forward lateral region 102a and rearward lateral region 104a may stay relatively constant in size and shape, while a curvature of longitudinal portions of adaptable proximity region 100, e.g., forward longitudinal region 102b and rearward longitudinal region 104b, are dynamically adjusted to accommodate, which may mean match, the curvature of lane 110 and/or the curved path of travel Pt of motorcycle 106.

Further, when motorcycle 106 is following a curved path of travel Pt and dynamically adapting proximity region for the lane curvature, ADAS 130 may also adjust a length, including an arc length, of forward and rearward proximity regions 102, 104 based on speed of motorcycle 106, as described above with respect to FIGS. 11-13.

Referring to FIGS. 15 and 16, in an embodiment, ADAS 130 may be configured to accept input from operator 108 to manually adjust adaptable proximity region 100, such that adaptable proximity region 100 is operator configurable. Operator 110 may change settings in order to increase or decrease sensitivity or following distances based on selected adaptable proximity region 100 parameters. Such parameters may include, but not necessarily be limited to, a forward proximity region 102 length L_{F} or rearward proximity region 104 length L_{R}.

Referring specifically to FIG. 15, ADAS 130 may be configured such that an operator 108 may select one of a plurality of forward proximity regions 102. Such a feature may be incorporated into an adaptive cruise control system to achieve different following distances based upon operator 108 preference. In an embodiment, and as depicted three adaptable forward proximity regions 102-1, 102-2 and 102-3 are available for selection by operator 108, based on operator 108 preference. Although three regions 102 are depicted and described, it will be understood that more or fewer than three proximity regions may be available for selection. Forward proximity region 102-1 is adapted for a relatively near following distance, which may also be a first forward length L_{F1}; forward proximity region 102-2 is adapted for a medium following distance, which may also be a second forward length L_{F2}; and forward proximity region 102-3 is adapted for a relatively far following distance, which may also be a third forward length L_{F3}.

The feature of a selectable forward proximity region 102 based on operator 108 selection may also be applied to a forward collision warning system, wherein the selection of a forward proximity region 102 determines when operator 108 is warned or alerted, or when operation of motorcycle 106 is autonomously controlled.

Referring to FIG. 16, ADAS 130 may be similarly configured such that an operator 108 may select one of a plurality of rearward proximity regions 104. In an embodiment, and as depicted three adaptable proximity regions 104-1, 104-2 and 104-3 are available for selection by operator 108, based on operator 108 preference. Although three regions 104 are depicted and described, it will be understood that more or fewer than three proximity regions may be available for selection. Rearward proximity region 104-1 is adapted for a relatively near following distance, which may also be a first rearward length L_{R1}; forward proximity region 104-2 is adapted for a medium following distance, which may also be a second rearward length LR₂; and rearward proximity region 104-3 is adapted for a relatively far following distance, which may also be a third rearward length L_{R3}.

The feature of a selectable rearward proximity region 102 based on operator 108 selection may be applied to a rearward collision warning system, wherein the selection of a rearward proximity region 104 determines when operator 108 is warned or alerted, or when operation of motorcycle 106 is autonomously controlled.

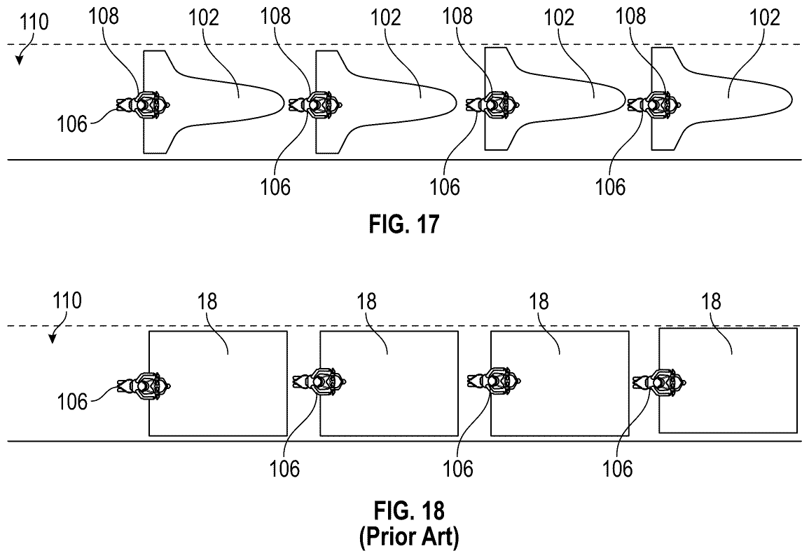

Referring to FIG. 17, four motorcycles 106 arranged in single-file formation within lane 110 is depicted. Each motorcycle 106 is equipped with ADAS 130 implementing adaptable proximity regions 100 (only forward proximity regions are depicted in FIG. 17 for the sake of simplicity). The use of adaptable proximity regions 100, particularly when used with adaptive cruise control or forward collision warning systems, allows operators 108 to keep motorcycles 106 safely and uniformly separated within lane 110.

Referring to FIG. 18, motorcycles 106 arranged in lane 110 with traditional ADASs that employ traditional forward proximity regions 18 is depicted. While use of traditional ADASs allows motorcycles 106 to be separated uniformly in a single-file formation, the rectangular shape fills the entire lane 110 width along the entire length of each region 18, precluding riding in a tight staggered formation as described further below.

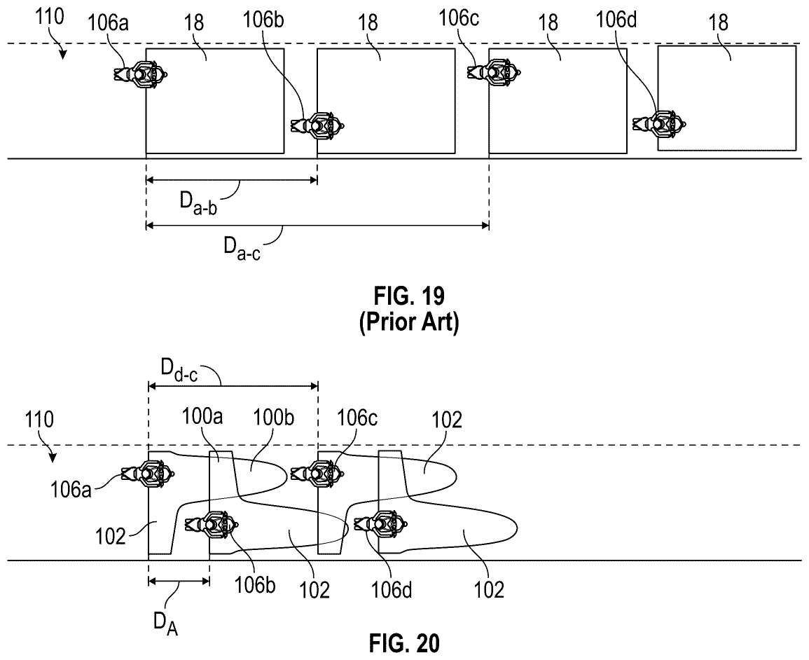

Referring also to FIG. 19, four motorcycles 106a, 106b, 106c and 106d riding in staggered formation in lane 110 using traditional ADASs with traditional forward proximity regions 18 is depicted. Although riding in staggered formation, i.e., motorcycles alternating position in a left-side-of-lane, right-side-of-lane pattern, is possible, longitudinal distances between pairs of motorcycles 106 is unnecessarily large, resulting in a particularly long formation. For example, a longitudinal distance between first motorcycle 106a in a left-side lane position and second motorcycle 106b in a right-side lane position is Da-b, which is slightly longer than a forward length of the traditional proximity region. Further, a longitudinal distance between first motorcycle 106a and third motorcycle 106c is Da-c, which is approximately twice the distance of Da-b due to the inherent characteristics of traditional proximity regions 18.

In contrast, and referring to FIG. 20, motorcycles 106a, 106b, 106c and 106d riding in staggered formation in lane 110 using adaptive proximity regions 100 with adaptive forward proximity regions 102 may safely ride in a much tighter staggered formation. A longitudinal distance between first motorcycle 106a and second motorcycle 106b, Da-b, is relatively short, and significantly less than the distance Da-b between first and second motorcycles 106a and 106b when using traditional proximity regions 18 (FIG. 19). Further, a longitudinal distance between first motorcycle 106a and third motorcycle 106c, distance Da-c, is also significantly less than distance Da-c when suing traditional proximity regions 18. As depicted, a distance Da-c for motorcycles 106 using adaptive proximity regions 100 with forward proximity regions 102, is half the comparable distance for motorcycles 106 using traditional proximity regions 18.

Customizing or adapting forward proximity regions 102 to include only those portions most relevant to a motorcycle, such as regions in front of, and in the path of travel of, efficient use of available space is possible, without compromising safety. In an embodiment, and as depicted, a portion of one forward proximity region 102, may overlap with a portion of another forward proximity region 102. In one such embodiment, a lateral proximity region 100a of a motorcycle 106 forward or another motorcycle 106 may overlap a longitudinal region 100b of the motorcycle rearward of motorcycle 106. For example, and as depicted, lateral proximity region 100a of motorcycle 106b overlaps with longitudinal proximity region 100b of motorcycle 106a. Referring also to FIG. 19, a configuration of overlapping proximity regions would not be possible with traditional proximity regions 18 as the ADAS of one motorcycle 106, e.g., motorcycle 106a, would detect the forward motorcycle 106, e.g., motorcycle 106b, prior to any overlap of proximity regions 18, thereby preventing a relatively close formation.

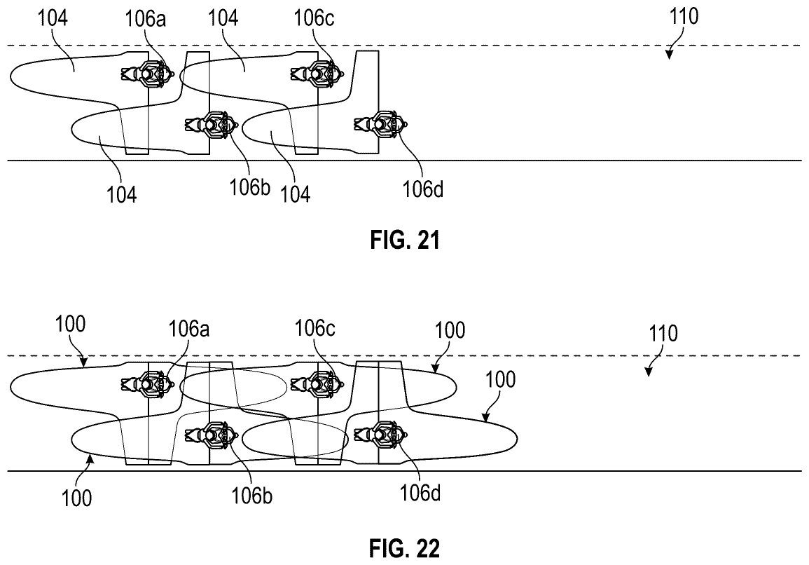

Referring to FIG. 21, four motorcycles 106a, 106b, 106c, and 106d, each employing ADAS 130 configured to produce adaptable proximity regions 100, are traveling in staggered formation in lane 110. In this configuration, each rearward proximity region 104 for each motorcycle 106 is depicted. Similar to the overlapping forward proximity regions 102 depicted and described above in FIG. 20, rearward proximity regions 104 also may be allowed to overlap in certain formations, including a staggered formation.

FIG. 22 depicts entire proximity regions 100 for four motorcycles 106 riding in a staggered formation in lane 110. For the sake of illustration, FIG. 22 combines all aspects of FIG. 20 depicting forward proximity regions 102, and all aspects of FIG. 21, depicting rearward proximity regions 104. As is evident from FIG. 22, considerable overlap of respective proximity regions 100 is possible for multiple motorcycles 106 riding in a close formation. Further, the proximity regions 100 of motorcycles 106 overlap, but none of the motorcycles 106 are inside of another motorcycle's proximity region 100.

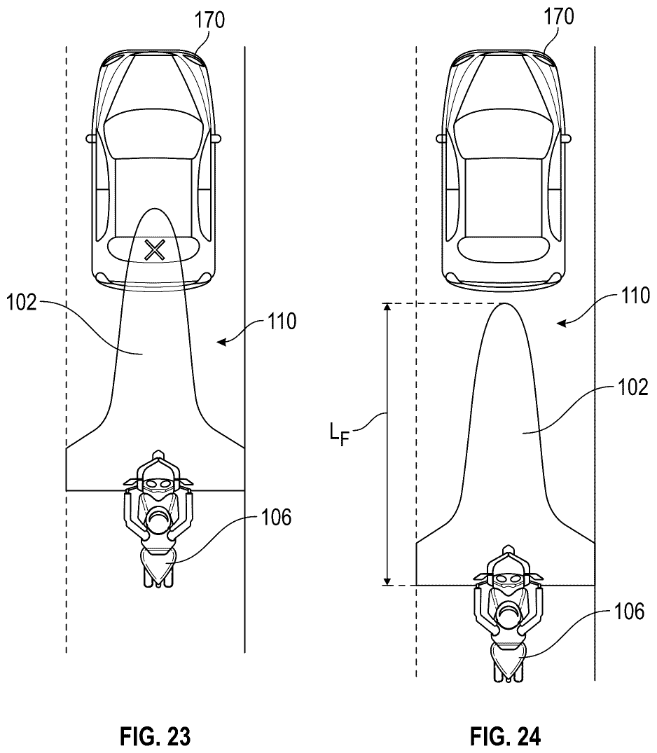

Referring to FIGS. 23 and 24, applications of adaptable proximity region 100 in forward-relevant ADASs, such as adaptive cruise control (ACC) and forward collision warning are depicted.

FIG. 23 depicts motorcycle 106 following automobile 170 too closely within lane 110, i.e., such that automobile 170 is within forward proximity zone 102. FIG. 24 depicts motorcycle 106 following automobile 170 at a minimum safe distance, i.e., outside of forward proximity region 102, as determined by ADAS 130.

With respect to applying forward proximity region 102 to an adaptive cruise control system, which may be part of ADAS 130, forward proximity region 102 can be used to define an acceptable following distance. In an embodiment, length L_{F} of forward proximity region 102 defines an acceptable following distance for the adaptive cruise control system. ADAS 130 with an adaptive cruise control system will modulate the speed of motorcycle 106 to maintain an appropriate target following distance that keeps a vehicle, such as automobile 170, outside of forward proximity region 102.

With respect to a forward collision warning system, an ADAS 130 may be configured to use forward proximity region 102 to define warning and/or intervention thresholds for warning of a forward collision or for forward collision avoidance applications.

The above-described and depicted forward proximity regions 102 and related methods and systems for determination and definition thereof may be incorporated into ADAS 130, or into known ADASs that include forward collision warning and adaptable cruise control systems, such as those described in the above-referenced patent and patent publications, as well as the following patents and patent publications, all of which are incorporated by reference herein in their entireties: EP 3640918A1, published on Apr. 22, 2020, entitled “Processing Unit and Processing Method for Front Recognition System, Front Recognition System, and Motorcycle,” and having an applicant Robert Bosch GmbH; EP 3800099A1, published Apr. 7, 2021, entitled “Leaning Vehicle,” and having an applicant Yamaha Hatsudoki Kabushiki Kaisha Iwata-shi; US 2020/0108830A1, published Apr. 9, 2020, entitled “Method for Automatically Adjusting the Speed of a Motorcycle,” and owned by having an applicant Robert Bosch GmbH; and U.S. Pat. No. 9,802,537, issued Oct. 31, 2017, entitled “Approach Notification Device of Straddle Type Vehicle,” and having an applicant Honda Motor Co., Ltd.

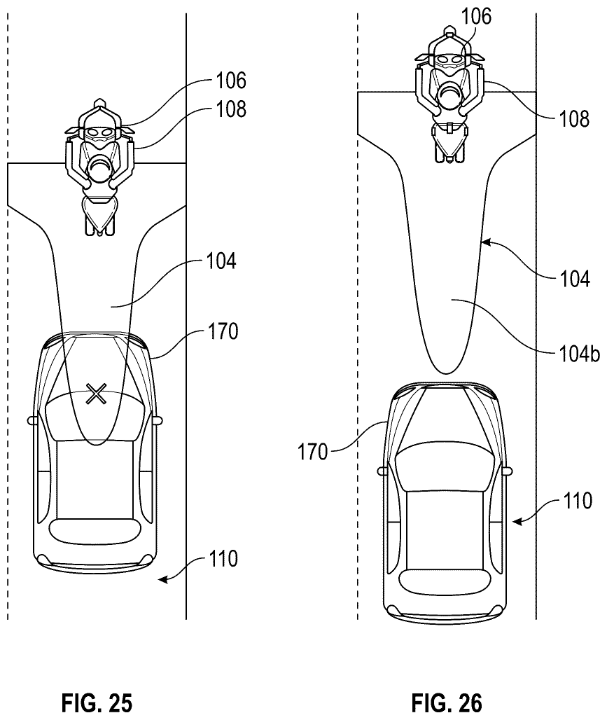

Referring to FIGS. 25 and 26, applications of adaptable proximity region 100 in rearward-relevant ADASs, such as reverse collision warning, rear traffic approaching, and blind spot detection systems are depicted. FIG. 25 depicts automobile 170 entering rearward proximity region 104. FIG. 26 depicts automobile 170 in lane 110 behind motorcycle 106, but not within rearward proximity region 104.

ADAS 130 may be configured to detect the rearward vehicle, such as automobile 170, entering rear proximity region 104 and also may be configured to detect whether the vehicle is approaching motorcycle 106 too quickly. When rearward approaching automobile 170 is detected in rearward proximity region 104, an ADAS 130 feature may be activated to make operator 108 aware, or may autonomously control certain operations of motorcycle 106 to avoid a collision.

In an embodiment, ADAS 130 may dynamically change the size and shape of rearward proximity region 130 in response to the speed of the approaching vehicle. In one such embodiment, ADAS 130 increase a length of longitudinal proximity region 104b in order to provide operator 108 an earlier warning, or in order to provide more time to implement autonomous intervention of motorcycle 106 operation.

In another embodiment, ADAS 130 may include using rearward proximity region 102 to detect another vehicle, such as another motorcycle in lane 110; in another embodiment, ADAS 130 may include using rearward proximity region 102 in conjunction with other blind-spot detection features to detect a vehicle in an adjacent lane.

The above-described and depicted rearward proximity regions 104 and related methods and systems for determination and definition thereof may be incorporated into ADAS 130, and also into known ADASs that include rearward collision warning, rearward collision avoidance and blind spot detection systems, such as those described in the above-referenced patent and patent publications, as well as the following patents and patent publications, all of which are incorporated by reference herein in their entireties: WO 2017/125190A1, published Jul. 27, 2017, entitled “Method for Detecting and Indicating an Object Which can be Found laterally of a Two-Wheeled Vehicle in the Blind Spot of the View of the Operator,” having an applicant Robert Bosch GmbH; U.S. Pat. No. 10,429,501, issued Oct. 1, 2019, entitled “Motorcycle Blind Spot Detection System and Rear Collison Alert Using Mechanically Aligned Radar,” having an applicant Continental Automotive systems, Inc.; U.S. Pat. No. 10,377,308, issued Aug. 13, 2019, entitled Motorcycle with Device for Detecting a Vehicle Approaching from the Rear,” having an applicant Ducati Motor Holding S.P.A.; and US 2019/0172354A1, published Jun. 6, 2019, entitled “Device for Warning a Two-Wheeler Driver of a Collision with Another Vehicle,” having an applicant Hochschule für Technik und Wirtschaft des Saarland.

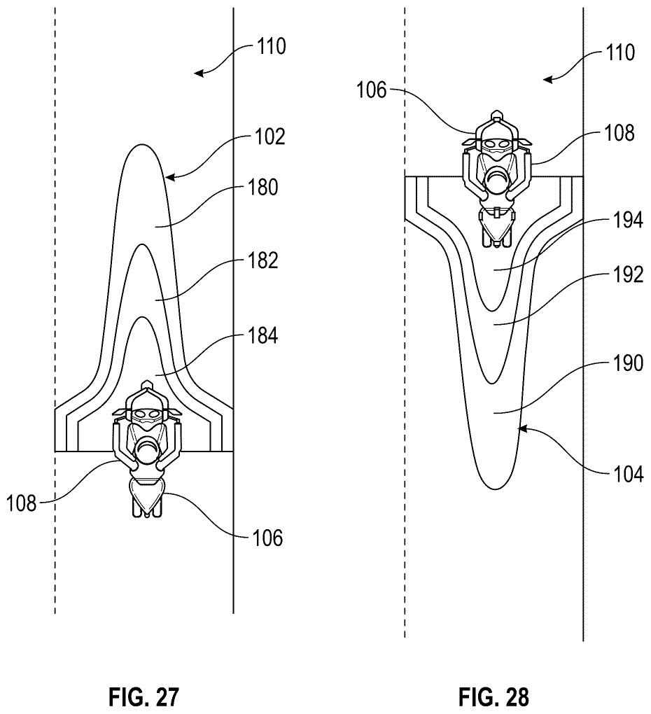

Referring to FIGS. 27 and 28, adaptable proximity region 100, and particularly forward proximity region 102 and rearward proximity region 104 may be divided into smaller sub-regions to provide higher resolution intervention options for ADAS 130 algorithms.

Referring specifically to FIG. 27, motorcycle 106 with ADAS 130 employing forward region 102 is depicted centrally in lane 110. As described above, forward proximity regions 102 may be applicable for adaptive cruise control, forward collision warning and forward collision intervention systems. Forward proximity region 102 includes a plurality of forward proximity sub-regions, which in an embodiment, comprises three forward proximity sub-regions, first forward proximity sub-region 180, second forward proximity sub-region 182, and third forward proximity sub-region 184. Although forward proximity region 102 is depicted and described as three sub-regions in this embodiment, it will be understood that forward proximity region 102 may comprise more or fewer than three sub-regions.

Each sub-region may be associated with a particular action or threshold. In an embodiment, forward proximity sub-region 180 may be considered a “level-one” sub-region and may be associated with a first or level-one action such as reducing the adaptive cruise set speed. The first action associated with first forward proximity sub-region 180 may optionally include an operator alert or warning, such as a flashing light, audible warning or haptic alert. First forward proximity sub-region 180 has a longest longitudinal length, such that an object entering sub-region 180 will be further from motorcycle 106 as comparted to sub-regions 182 and 184, such that a level one action may be less severe than actions associated with sub-regions 182 and 184.

Second forward proximity sub-region 182 may be considered a “level-two” sub-region and may be associated with a second or level-two action, such as cutting or operating the throttle so as to reduce the speed of motorcycle 106. This level-two action may be considered somewhat more severe or intrusive as compared to a level-one action, such as reducing a cruise speed. A warning or alert, including a warning or alert that is more severe, e.g. higher-speed flash rate, louder sound, more intense vibration, etc., may also be implemented as part of the level-two action. Second forward proximity sub-region 182 has a longitudinal length that is less than the length of first sub-region 180, such that an object in second sub-region 182 is closer to motorcycle 106 as compared to an object in first forward proximity sub-region 180, such that a danger to operator 108 is more imminent, and a more drastic action warranted.

Third forward proximity sub-region 184 may be considered a “level-three” sub-region and may be associated with a third or level-three action, such as providing an active warning and applying brakes to quickly slow motorcycle 106 in order to reduce the risk or severity of a collision. This level-three action may be considered most severe or intrusive as compared to a level-one or level-two action. Third forward proximity sub-region 184 has a longitudinal length that is less than the length of first and second sub-regions 180, 182, such that an object in third sub-region 184 is closer to motorcycle 106 as compared to an object in first forward proximity sub-region 180 or second forward proximity sub-region 182.

Referring to FIG. 28, motorcycle 106 with ADAS 130 that employs rearward proximity region 104 having multiple rearward proximity sub-regions, including rearward proximity sub-region 190, rearward proximity sub-region 192 and rearward proximity sub-region 194. ADAS 130 may employ multiple rearward proximity sub-regions with or without multiple forward sub-regions as depicted and described above with respect to FIG. 28.

Use of rearward proximity region 104 having multiple rearward proximity sub-regions may be employed by ADAS 130 for rearward collision warnings or rearward traffic approach warnings.

Rearward proximity sub-regions are defined and used similarly to the forward proximity sub-regions described above with respect to FIG. 27.

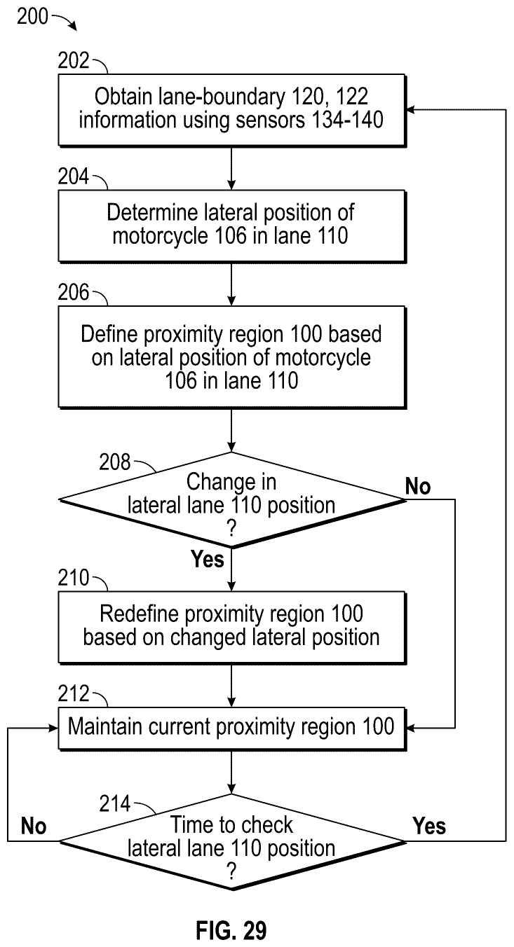

The various features, systems and methods relating to determining and defining adaptable proximity regions 110, and operating motorcycle 106, as described above, may be part of, or incorporated into, ADAS 130. Referring to FIG. 29, in one particular embodiment, method 200 for operating motorcycle 106, which includes dynamically determining adaptable proximity regions 110, is depicted. In an embodiment, the steps of method 200 may be stored as computer-readable instructions in ADAS 130, including in a non-transitory embodiment of memory 148 (see also FIG. 4).

At Step 202, information or data relating to lane boundary 120 and/or lane boundary 122 using sensors 134-140 is obtained. As described above, such information may be obtained by various sensing and detecting devices and systems, including cameras, radar, lidar and so on.

At Step 204 the obtained information or data relating to lane boundary 120 and/or lane boundary 122 is used to determine a lateral position of motorcycle 106 in lane 110. In an embodiment processor 146 is configured to determine the lateral position of motorcycle 106 in lane 110.

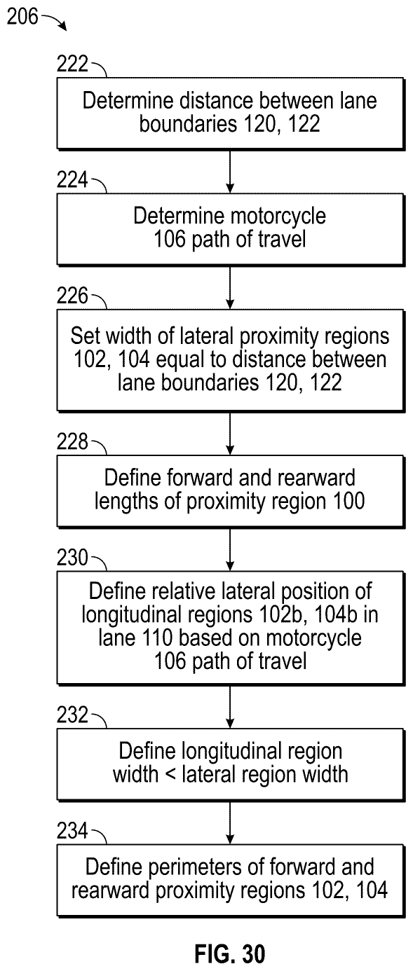

At Step 206, adaptable proximity region 100 is determined based at least in part on the determined lateral position of motorcycle 106 in lane 110. The characteristics of adaptable proximity region 100, such as size and shape, may be determined based on steps described above with respect to FIGS. 1-28, and as also described below with respect to FIG. 30.

At Step 208, it is determined whether a lateral-lane position of motorcycle 106 has changed. In an embodiment, ADAS 130 determines whether a change in lateral position has occurred. Determining whether a change in lateral position has changed may comprise comparing a first or prior lateral position of motorcycle 106 with a second or subsequent lateral position of motorcycle 106.

If at Step 208, it is determined that no change in the lateral position of motorcycle 106 has occurred, then the current adaptable proximity region 100 is maintained at Step 210.

If at Step 208 it is determined that a change in the lateral position of motorcycle 106 has occurred, then adaptable proximity region 100 is redefined based on the updated or new lateral position of motorcycle 106 in lane 110.

In an embodiment, ADAS 130 repeatedly checks the lateral lane position of motorcycle 106 in lane 110 so as to frequently redefine adaptable proximity region 100. In an embodiment, the lateral lane position of motorcycle 106 in lane 110 is determined periodically using a time function. At Step 214, if the predetermined period of time has passed, then the process starts anew, with new lane-boundary information being obtained at Step 202. If at Step 214, the period of time has not expired, then the current adaptable proximity region 100 is maintained at Step 212.

Referring to FIG. 30, an embodiment of a method of 206 of defining adaptable proximity region 100 having forward proximity region 102 with forward lateral region 102a and forward longitudinal region 104a, and having rearward proximity region 104 with rearward lateral region 104a and rearward longitudinal region 104b, is depicted.

At Step 222, a distance between first lane boundary 120 and second lane boundary 122 is determined.

At Step 224, a path of travel, or forward trajectory, of motorcycle 106 is determined. The path of travel may be estimated based on various inputs received by ADAS 130, including data and information provided by sensors 134-140. As motorcycle 106 moves laterally within lane 110, the path of travel of motorcycle 106 changes.

At Step 226, a width of lateral proximity region 102 of adaptable proximity region 100 is defined, including widths of forward and rearward lateral regions 102a and 104a, to be substantially equal to a distance between first lane boundary 120 and second lane boundary 122.

At Step 228, a forward length of adaptable proximity region 102, based on one or more factors as described above with respect to FIGS. 1-28, such as motorcycle 106 speed, operator 108 preference input, detected object or vehicle proximity, and so on, is defined.

At Step 230, a relative position of longitudinal forward region 102 between first lane boundary 120 and second lane boundary 122 is defined based on the determined or estimated forward path of travel of motorcycle 106. In an embodiment, and as described above, the longitudinal forward region 102 includes portions of the forward path of travel of motorcycle 106. As also described above, as motorcycle 106 moves laterally within lane 110, the path of travel of motorcycle 106 changes, and consequently, the relative position of longitudinal forward region 102 shifts laterally as needed to follow the path of travel of motorcycle 106.

At Step 232, a width of forward and rearward longitudinal regions 102b and 102a is defined to be less than the width of lateral proximity region 102 and the distance between first lane boundary 120 and second lane boundary 122, thereby excluding lateral portions of lane 110 adjacent to forward and rearward longitudinal regions 102b and 104b from adaptable proximity region 100. As described above, excluding such lateral and adjacent portions of lane 110, i.e., leaving spaces 160, allows for multiple motorcycles 106 to enter into regions not otherwise available, and to ride in tighter and closer staggered formations.

At Step 234, perimeters of forward proximity region 102 and rearward proximity region 104 in view of Steps 222 to 232, are defined, thereby defining a shape and size of adaptable proximity region 100.

Embodiments of the disclosure also include non-transitory computer-readable mediums onto which are stored instructions that are executable by processor 146, and cause the processor to perform the methods described above, including the methods of FIGS. 29 and 30.

The invention is not restricted to the details of the foregoing embodiment(s). The invention extends to any novel one, or any novel combination, of the features disclosed in this specification (including any incorporated by reference references, any accompanying claims, abstract and drawings), or to any novel one, or any novel combination, of the steps of any method or process so disclosed. The above references in all sections of this application are herein incorporated by references in their entireties for all purposes.

While the aforementioned particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

All of the above patents and patent publications are incorporated herein by reference in their entirety for all purposes, except for express definitions and patent claims contained therein.

What is claimed is:

1. A method of operating a motorcycle, comprising:
obtaining lane-boundary information using a sensor of the motorcycle, the lane-boundary information relating to one or more lane boundaries that define a lane of a road;
determining a first lateral position of the motorcycle within the lane of the road based on the obtained lane-boundary information;
defining an adaptable proximity region that includes a first proximity region defined at least in part by the first lateral position of the motorcycle within the lane, the first proximity region defining a first area of the lane proximal to the motorcycle and having a first proximity-region shape and a first proximity-region size;
determining a second lateral position of the motorcycle within the lane of the road, the second lateral position of the motorcycle within the lane being different from the first lateral position of the motorcycle within the lane of the road; and
redefining the adaptable proximity region to include a second proximity region based on a change in position of the motorcycle from the first lateral position to the second lateral position, the second proximity region defining a second area of the lane having a second proximity-region shape and a second proximity-region size, the second area of the lane being different than the first area of the lane, thereby adapting the adaptable proximity region to the change in lateral position of the motorcycle within the lane.

2. The method of claim 1, further comprising changing the first proximity-region size based upon a speed of the motorcycle.

3-4. (canceled)

5. The method of claim 1, further comprising changing the first proximity-region size based upon an operator-selectable input received by the motorcycle.

6. The method of claim 1, wherein the first proximity region includes a lateral proximity region and a longitudinal proximity region, and the lateral width of the lateral proximity region is greater than the lateral width of the longitudinal region, and a longitudinal length of the longitudinal proximity region is greater than a longitudinal length of the lateral proximity region.

7-9. (canceled)

10. The method of claim 6, wherein the lateral width of the longitudinal region is less than a lateral width of the lane of the road.

11. The method of claim 10, wherein the longitudinal proximity region extends along a first path of travel of the motorcycle extending longitudinally and forward of the motorcycle.

12. The method of claim 6, wherein a longitudinal proximity region of the second proximity region extends along a second path of travel of the motorcycle extending longitudinally and forward of the motorcycle, the second path of travel laterally offset in the lane from the first path of travel.

13. The method of claim 1, further comprising changing the second proximity-region shape based upon a curvature of the lane of the road.

14-16. (canceled)

17. The method of claim 6, wherein the longitudinal proximity region includes a forward longitudinal proximity region and a rearward longitudinal proximity region.

18-20. (canceled)

21. The method of claim 1, wherein redefining the adaptable proximity region to include a second proximity region includes defining a lateral width of the second proximity region to be the same as a lateral width of the first proximity region.

22-24. (canceled)

25. An advanced driver assistance system (ADAS) for a motorcycle, comprising:
a first sensor for detecting a boundary of a lane of a road;
a control unit in communication with the first sensor via an interface, the control unit including a processor and memory device storing instructions readable by the processor, the processor configured to:
receive information from the first sensor regarding the boundary of the lane of the road,
determine a lateral position of the motorcycle within the lane based at least in part on the information from the first sensor,
define an adaptable proximity region that includes a first proximity region defined at least in part by the first lateral position of the motorcycle within the lane, the first proximity region defining a first area of the lane proximal to the motorcycle and having a first proximity-region shape and a first proximity-region size;
determine a second lateral position of the motorcycle within the lane of the road, the second lateral position of the motorcycle within the lane being different from the first lateral position of the motorcycle within the lane of the road; and
redefine the adaptable proximity region to include a second proximity region based on a change in position of the motorcycle from the first lateral position to the second lateral position, the second proximity region defining a second area of the lane having a second proximity-region shape and a second proximity-region size, the second area of the lane being different than the first area of the lane, thereby adapting the adaptable proximity region to the change in lateral position of the motorcycle within the lane; and
a warning device in electrical communication with the control unit.

26-30. (canceled)

31. The ADAS of claim 25, further comprising a second sensor that comprises a radar or lidar system, and wherein the first sensor comprises a camera system.

32. The ADAS of claim 25, wherein the processor is further configured to change the first proximity-region size based upon a speed of the motorcycle or based upon an operator-selectable input received by the motorcycle.

33. (canceled)

34. The ADAS of claim 25, wherein the processor is further configured to define the first proximity region to include a lateral proximity region and a longitudinal proximity region.

35-36. (canceled)

37. The ADAS of claim 34, wherein the processor is further configured to define a lateral width of the longitudinal region to be less than a lateral width of the lane of the road, and to define the longitudinal proximity region to extend along a first path of travel of the motorcycle extending longitudinally and forward of the motorcycle.

38. (canceled)

39. The ADAS of claim 37, wherein the processor is further configured to define a longitudinal proximity region of the second proximity region extending along a second path of travel of the motorcycle extending longitudinally and forward of the motorcycle, the second path of travel laterally offset in the lane from the first path of travel.

40-47. (canceled)

48. A motorcycle that includes a front wheel, a rear wheel, a frame, an engine, and the ADAS of claim 25.

49. (canceled)

50. A method of dynamically defining a region proximal to a motorcycle in a lane of a road, comprising:
determining a lateral position of the motorcycle in the lane of the road;
defining a forward proximity region having a forward proximity region shape defined by an outer perimeter of the forward proximity region, a forward length, a first lateral forward width at a first end that extends substantially from the first lane boundary to the second lane boundary along an axis normal to the first and second lane boundaries and that intersects a portion of the motorcycle, and a second lateral forward width at a second end forward of the motorcycle and that is less than the first lateral forward width; and
changing the forward proximity region shape based on a change of the lateral position of the motorcycle in the lane of the road.

51. (canceled)

52. The method of claim 50, further comprising defining a rearward proximity region that is rearward of the forward proximity region, and wherein defining the rearward proximity region comprises defining the rearward proximity region to have a rearward length, a first rearward lateral width at a first end that extends substantially from the first lane boundary to the second lane boundary along the axis normal to the first and second lane boundaries and that intersects the portion of the motorcycle, and a second lateral rearward width at a second end rearward of the motorcycle and that is less than the first lateral rearward width.

53. (canceled)

54. The method of claim 50, wherein defining a forward proximity region comprises defining the forward proximity region to encompass a portion of an expected path of travel of the motorcycle, wherein the expected path of travel is defined by an axis extending in a direction from a rear wheel of the motorcycle toward a front wheel of the motorcycle.

55-79. (canceled)
